(19) United States
(12) Patent Application Publication
(10) Pub. No.: US 2026/0003806 A1
(43) Pub. Date: Jan. 1, 2026

(54) Z-Dimension Cache Layer Pipelining

(71) Applicant: Advanced Micro Devices, Inc., Santa Clara, CA (US)

(72) Inventor: Paul James Moyer, Fort Collins, CO (US)

(73) Assignee: Advanced Micro Devices, Inc., Santa Clara, CA (US)

(21) Appl. No.: 18/757,305

(22) Filed: Jun. 27, 2024

(51) Int. Cl. G06F 13/16; G06F 13/40

(52) U.S. Cl. CPC G06F 13/1689; G06F 13/1673; G06F 13/4068; G06F 13/4256

(57) ABSTRACT

Z-dimension cache layer pipelining is described. In one or more implementations, a device includes a stacked cache having a plurality of cache layers communicatively pipelined by an interconnect that outputs responses from the cache layers for processing during a common clock cycle. In one or more implementations, a system includes a stacked cache having a plurality of cache layers, with each cache layer implemented on a different respective die within a stack of dies, a cache controller configured to send requests to the cache layers and process responses received from the cache layers, and an interconnect configured to synchronize communication between the cache controller and the stacked cache by pipelining the responses to arrive at the cache controller during a common clock cycle.

### BACKGROUND

A die is a piece of semiconductor material used to fabricate an integrated circuit for a semiconductor device. Semiconductor devices often include multiple dies, including vertically stacked dies that help achieve a small footprint and improve electrical performance.

### BRIEF DESCRIPTION OF THE DRAWINGS

FIG. 1 is a block diagram of a non-limiting example system that uses Z-dimension cache layer pipelining.

FIG. 2 is a block diagram of another non-limiting example system that uses Z-dimension cache layer pipelining.

FIG. 3 depicts a timing diagram of cache communications exchanged in a non-limiting example system using Z-dimension cache layer pipelining.

FIG. 4 depicts a procedure for using Z-dimension cache layer pipelining.

FIG. 5 is a block diagram of a processing system configured to execute one or more applications, in accordance with one or more implementations.

### DETAILED DESCRIPTION

Processing devices, such as a central processing unit (CPU), a graphics processing unit (GPU), an accelerator unit, a system on chip (SoC), and the like, are semiconductor devices implemented on semiconductor dies. A processing device typically includes a base die used to provision a processor core and various other elements that support the core.

A cache is one support element that benefits from being located as close as possible to the core. To implement a cache near the core without increasing a footprint of the base die, some devices layer the cache onto additional dies, which are stacked above or below parts of the base die that support the core. In a typical stacked cache, each cache layer is connected to another cache layer by micro bumps, vias, or some other interface technology. Communications move between different layers using pipelining. A cache controller communicates from the base die to a first cache layer in a first stacked die (e.g., via micro bumps between the base die and the first die). Then, the first cache layer communicates with a second cache layer in a second stacked die (e.g., via micro bumps between the first and second dies). Conventional pipelining does not easily scale beyond a few stacked dies. When many stacked dies are used (e.g., four, fifty, or one hundred), more communication delay exists between the base die and the top dies than between the base die and the lower dies. Too much variation in response latency from each die in the stack drives complexity at the cache controller, which limits a quantity of dies that is usable as a stacked cache.

High bandwidth memory stacks represent another stacking technology implemented on stacked dies. Memory stacks communicate directly between a memory controller (e.g., on a base die) and each stacked die, without any intermediary pipelining. Memory stacks suffer from high complexity costs to implement direct connections between each stacked die and the base die, as well as to enable their controllers to be able to deconflict individual responses received from different dies at slightly different times. Like with conventional cache pipelining, these added complexities effectively limit a quantity of dies that can be used in a memory stack.

Z-dimension cache layer pipelining is described herein for achieving a consistent response latency among multiple layers of a vertically stacked cache. With Z-dimension cache layer pipelining, there is no difference in response latency for responses from each layer in the cache, regardless of physical distance from the base layer. The response latency is consistent as the responses are ready on a same clock cycle.

By way of example, a system includes a stacked cache implemented on a stack of dies. A base layer of the stacked cache is implemented on a base die (e.g., a first die) in the stack of dies. A number (N) of other cache layers of the stacked cache are individually implemented on different corresponding dies, which are stacked on top of the base die. In one or more implementations, a cache controller is implemented on a same die in the stack of dies as a first cache layer in the stacked cache (e.g., the base die). In at least one aspect, each die stacked on the base die is an identical copy. In an example, the dies are pipelined through an interconnect that communicatively couples the base die to each individual stacked die. For instance, the dies are daisy chained by the interconnect to enable communications to move up and down through the stacked cache by passing, in a successive manner, from one cache layer to the next.

Due to a physical distance from the cache controller on the base layer, communication latency to and from cache layers located higher in the stacked cache is expected to be greater than from cache layers positioned lower in the stacked cache. To achieve consistent communication latency with each cache layer, and ensure responses from the different cache layers are ready at the base die at the same time, the interconnect is configured to add one or more clock cycles or partial clock cycles (e.g., per intermediate cache layer) to requests that traverse up and responses that traverse down through the multiple layers of the stacked dies. As used herein, the term request refers to an instruction, a message, or a command for data to be stored or retrieved from the stacked cache. For example, the cache controller communicates a request to the stacked cache to cause existing data stored in one or more of the cache layers to be retrieved from one or more storage circuits (e.g., cache layers) that maintain the data. As another example, the cache controller communicates a request to the stacked cache to cause new data to be stored in one or more of the cache layers to improve efficiency of a subsequent retrieval of the data (e.g., in response to a subsequent request) from one or more storage circuits (e.g., cache layers) where the data is stored. The term response, as used herein, refers to an instruction, a message, or a command for confirming data that is stored or for conveying data retrieved from the stacked cache. For example, the cache controller receives a response from the stacked cache that indicates when data is successfully stored in one or more of the cache layers (e.g., storage circuits) that maintain the data. As another example, the cache controller receives a response from the stacked cache that includes the data retrieved from one or more storage circuits (e.g., cache layers) where requested data is stored.

In one or more implementations, for each intermediate cache layer that a request or response passes through, the interconnect pipelines the communication signals by delaying them for one or more clock cycles of latency. The communication signals are delayed when going up through the stacked cache, and similarly delayed on the way down through the stacked cache. In one or more aspects, adding cycles or partial cycles within the interconnect includes switching clock phases (e.g., switching phases at each stacked cache layer for every up request and down response). By way of example, if a half clock cycle is sufficient to cover cross-die latency, and is added for every intermediate cache layer, then every other cache layer is clocked on an inverted clock to offset.

By controlling the latency of the pipelined communications this way, responses from each cache layer of the stacked cache are made ready for processing by the cache controller at the same time (e.g., during the same clock cycle). Said differently, there is little to no difference in response latency experienced by the cache controller no matter the cache layer that a request is sent from. Consistent response latency is achieved because each response is made available to the controller on the same cycle. In this way, cache controller complexity is reduced relative to a conventional pipelining scheme, and a much greater quantity of stacked dies is possible for implementing a stacked cache.

In one or more aspects, the techniques described herein relate to a system including: a stacked cache having a plurality of cache layers, each cache layer implemented on a different respective die within a stack of dies, a cache controller configured to send requests to the cache layers and process responses received from the cache layers, and an interconnect configured to synchronize communication between the cache controller and the stacked cache by pipelining the responses to arrive at the cache controller during a common clock cycle.

In one or more aspects, the techniques described herein relate to a system, wherein the cache controller is configured to process the responses during a period of time defined by the common clock cycle.

In one or more aspects, the techniques described herein relate to a system, wherein the interconnect is further configured to synchronize the communication by causing an approximately same response latency between the cache controller and each of the cache layers.

In one or more aspects, the techniques described herein relate to a system, further including: a scheduler configured to buffer the responses for processing by the cache controller during the common clock cycle.

In one or more aspects, the techniques described herein relate to a system, wherein the scheduler is implemented on a same die in the stack of dies as the cache controller.

In one or more aspects, the techniques described herein relate to a system, wherein the scheduler is configured to order each of the responses according to a temporal order of the requests.

In one or more aspects, the techniques described herein relate to a system, wherein the scheduler is configured to receive the responses in a different order than the temporal order of the requests.

In one or more aspects, the techniques described herein relate to a system, wherein the interconnect includes delay logic at each of the cache layers to uniquely delay the responses according to a respective position of a responding cache layer within the stacked cache.

In one or more aspects, the techniques described herein relate to a system, wherein the cache controller is implemented on a same die in the stack of dies as a first cache layer in the stacked cache.

In one or more aspects, the techniques described herein relate to a system, wherein the interconnect includes micro bumps, hybrid bonds, or through-silicon vias that electrically couple each of the cache layers to at least one adjacent cache layer from the stacked cache.

In one or more aspects, the techniques described herein relate to a device including: a stacked cache having a plurality of cache layers communicatively pipelined by an interconnect that outputs responses from the cache layers for processing during a common clock cycle.

In one or more aspects, the techniques described herein relate to a device, wherein each of the cache layers is implemented on a different respective die within a stack of dies.

In one or more aspects, the techniques described herein relate to a device, wherein the interconnect includes delay logic at each of the cache layers to cause an approximately same response latency from each of the cache layers.

In one or more aspects, the techniques described herein relate to a device, further including: a cache controller configured to send requests to the cache layers and process the responses output from the cache layers during the common clock cycle.

In one or more aspects, the techniques described herein relate to a device, wherein the cache controller includes a scheduler that orders the responses based on a temporal order of the requests.

In one or more aspects, the techniques described herein relate to a device, wherein the scheduler is configured to buffer the responses for processing by the cache controller during the common clock cycle.

In one or more aspects, the techniques described herein relate to a device, further including: a processor operatively coupled to the stacked cache.

In one or more aspects, the techniques described herein relate to a method including: maintaining, by a scheduler in communication with a cache controller, a temporal order of requests sent through an interconnect to a plurality of cache layers in a stacked cache, receiving, by the scheduler, responses sent through the interconnect from the stacked cache, and buffering, by the scheduler, the responses to be output during a common clock cycle for processing by the cache controller in the temporal order of the requests.

In one or more aspects, the techniques described herein relate to a method, wherein the responses are received in a different order than the temporal order of the requests, and buffering the responses includes ordering the responses to be buffered in the temporal order of the requests.

In one or more aspects, the techniques described herein relate to a method, further including: preventing, by the scheduler, cache controller access to the responses until a corresponding response to each of the requests is received for processing during the common clock cycle.

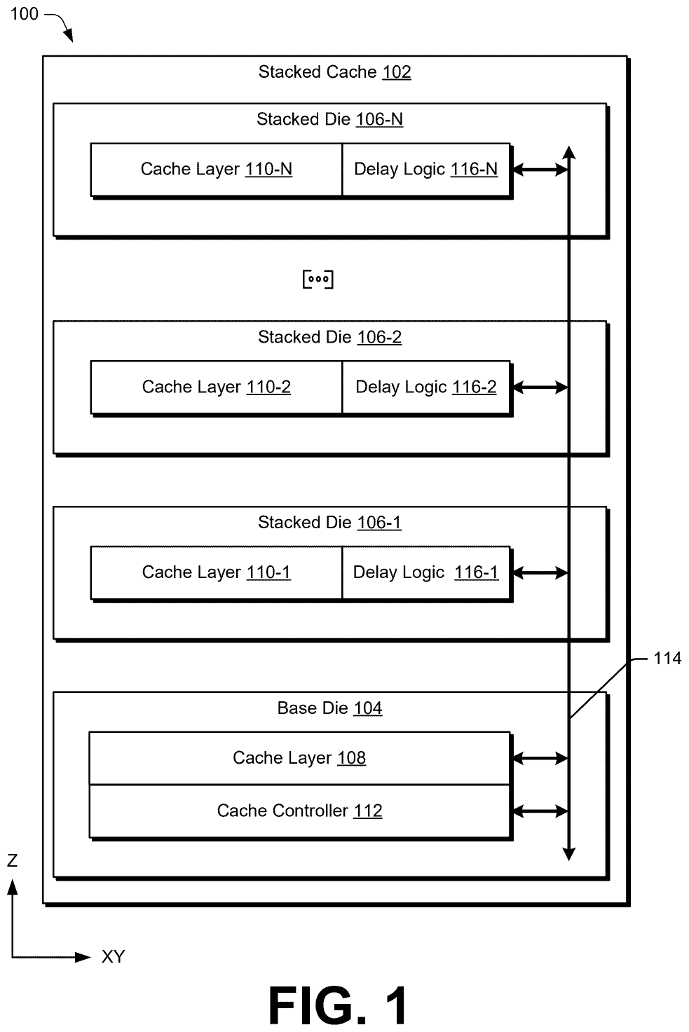

FIG. 1 is a block diagram of a non-limiting example of a system 100 that uses Z-dimension cache layer pipelining. In this example, the system 100 represents an example of a stacked cache 102, which is implemented on multiple stacked semiconductor dies. It is to be appreciated that in variations, and without departing from the spirit or scope of the described techniques, the system 100 and the individual components illustrated therein include more, fewer, and/or different hardware components (e.g., a processor core, additional caches, networking interfaces, other controllers, memory, accelerator cores). In one example for instance, an interface to a processor core is operable with an interface of the stacked cache 102.

The system 100 is part of any type of processing system, device, or apparatus that benefits from a cache. Examples of systems, devices, and apparatuses in which the system 100 is implemented include, but are not limited to, one or more server computers, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer, and other computing devices or systems.

The stacked cache 102 includes hardware components, referred to as storage circuits, that are configured as a data store, a memory, or a storage to store data (e.g., at least temporarily) so that a future request for the data is served faster from the stacked cache 102 than from other storage circuits (e.g., a memory or data store) maintained outside the system 100. Examples of a data store, a memory, or a storage include main memory (e.g., random access memory), another cache that is separate from the stacked cache 102, secondary storage (e.g., a mass storage device), and removable media (e.g., flash drives, memory cards, compact discs, and digital video disc), or other electronic circuit configured to store data. In one or more implementations, the stacked cache 102 is an example of a memory cache, such as a single cache (e.g., L0 cache) or one or more levels of cache that are included in a hierarchy of multiple cache levels (e.g., L0, L1, L2, L3, and L4). In one or more examples, the stacked cache 102 is implemented at least partially in software or implementable in different ways without departing from the spirit or scope of the described techniques.

The system 100 makes the stacked cache 102 available to one or more requestors (not shown). The term “requestor” as used herein represents any individual processing element that reads and executes instructions (e.g., of a program), examples of which include to add, to move data, and to branch. Examples of a requestor that utilizes the stacked cache 102 include, but are not limited to, a processing core, a CPU, a GPU, a field programmable gate array (FPGA), an accelerator, an accelerated processing unit (APU), an intelligent processing unit (IPU), and a digital signal processor (DSP), to name a few.

In one or more implementations, the stacked cache 102 is at least one of smaller than other data stores of the system 100, faster at serving data to a requestor than these other data stores, or more efficient at serving data to the requestor than these other data stores. Additionally, or alternatively, the stacked cache 102 is located closer to a requestor than other data stores within the system 100. It is to be appreciated that in various implementations the stacked cache 102 has additional or different characteristics that make serving at least some data to a requestor from the stacked cache 102 advantageous over serving such data from other data stores in the system 100.

The stacked cache 102 has a plurality of cache layers implemented on a stack of dies. As used herein, the term cache layer refers to an individual electronic circuit or storage circuit, that is configured to store data to implement at least a portion of a cache. In at least one aspect, each of the cache layers of the stacked cache 102 is a respective storage or cache circuit implemented on a different die in the stack of dies. For example, the stacked cache 102 includes an electronic circuit implemented as a first cache circuit on a base die 104, and separate electronic circuits implemented as additional cache circuits on a stacked die 106-1 through a stacked die 106-N, where “N” represents a quantity of N stacked dies of any integer greater than zero. The base die 104 and each of the stacked die 106-1 through the stacked die 106-N is an individual piece of semiconductor material used to fabricate a particular electronic circuit (e.g., cache circuit) that implements a corresponding cache layer of the stacked cache 102. Numerous examples of semiconductor materials usable to form the base die 104 and the stacked die 106-1 through the stacked die 106-N exist including, by non-limiting example, silicon, sapphire, ruby, gallium arsenide, glass, or any other semiconductor substrate.

The base die 104 is arranged on an XY-plane and the stacked die 106-1 through the stacked die 106-N are positioned one on top of another either above or below the base die 104. For example, the stacked die 106-1 through the stacked die 106-N are stacked in a Z-dimension along a Z-axis that is normal to the XY-plane on which the base die 104 is arranged. The stacked die 106-1 through the stacked die 106-N are individually labeled, in order of increasing distance from the base die 104, as a stacked die 106-1 through stacked die 106-N. The base die 104 and each of the stacked die 106-1 through the stacked die 106-N implement a different cache layer of the stacked cache 102.

The base die 104 includes a single cache layer, as a cache layer 108, which represents a first layer of the stacked cache 102. The cache layer 108 implements an interface to a requestor of the stacked cache 102. For example, processor core elements (not shown) communicate over the interface in the cache layer 108 to store data into, or load data from, the stacked cache 102.

The stacked die 106-1 through the stacked die 106-N collectively support a quantity of N cache layers, which are individually labeled as a cache layer 110-1 through a cache layer 110-N. In one or more examples, the cache layer 110-1 through the cache layer 110-N are identical copies of each other. For example, each of the cache layer 110-1 through the cache layer 110-N includes an equal amount of cache memory. In other implementations, one or more of the cache layer 110-1 through the cache layer 110-N is unique. For example, the cache layer 110-1 has a different amount of cache memory than a cache layer 110-2 and/or the cache layer 110-N.

The system 100 includes a cache controller 112 configured to send requests to the cache layers and process responses received from the cache layers. In at least one example, the cache controller 112 is implemented on the base die 104 in conjunction with the cache layer 108. In one or more other examples, the cache controller 112 is implemented on one or more of the stacked die 106-1 through the stacked die 106-N, such as, in conjunction with one or more of the cache layer 110-1 through the cache layer 110-N. The cache controller 112 is an electronic circuit that manages the retrieval, storage, and delivery of data at the stacked cache 102. For example, the cache controller 112 requests data be loaded or stored at one or more of the cache layer 110-1 through the cache layer 110-N to satisfy a requestor of the system 100, which is communicating over the cache interface implemented by the cache layer 108. The cache controller 112 coordinates transfers of data to and from the cache layer 110-1 through the cache layer 110-N by issuing cache layer requests and processing cache layer responses. The cache controller 112 determines where to store new data, when to fetch additional data from adjacent addresses to be ready in case a requestor will use the data soon after, and what old data to discard from the stacked cache 102 if cache memory within the stacked cache 102 is full. In one or more implementations, to improve performance of the stacked cache 102, the cache controller 112 maintains a table of addresses associated with data already stored in the stacked cache 102. The cache controller 112 checks the table to determine if a requestor is referencing data that is already present in memory of the stacked cache 102.

The system 100 includes an interconnect 114 configured to synchronize communication between the cache controller 112 and the stacked cache 102 by pipelining the responses to arrive at the cache controller 112 during a common clock cycle. For example, the cache controller 112 and the stacked cache 102 communicate according to a common clock cycle of the system 100. The pipelining by the interconnect 114 enables the responses to arrive at the cache controller 112 during a period of time (e.g., a pulse) defined by the common clock cycle. In at least one example, the interconnect 114 is an electronic circuit implemented within the stacked cache 102, which passes vertically (e.g., along the Z-axis) from the base die 104 and through each of the stacked die 106-1 through the stacked die 106-N. The electronic circuit of the interconnect 114 communicatively couples or links the base die 104 to each of the stacked die 106-1 through the stacked die 106-N. For example, the interconnect 114 includes a wire, a bus, a trace, or other electrical coupling that communicatively links the stacked die 106-1 to the base die 104, as well as the stacked die 106-2. The stacked die 106-N, which in this example is a furthest stacked die from the base die 104, is communicatively coupled via the interconnect 114 to the stacked die 106-2, which is a second furthest stacked die from the base die 104.

In one or more implementations, the electronic circuit of the interconnect 114 includes interface technology configured as an electrical connection or electrical link to electrically couple each of the cache layer 110-1 through the cache layer 110-N to at least one adjacent layer from the stacked cache 102. For example, the interconnect 114 is a wire, a bus, or a trace implemented as a die-to-die interconnect that electrically couples together the layers of the stacked cache 102. The interconnect 114, for instance, includes an electrical circuit having micro bumps, hybrid bonds, through-silicon vias, or other interface technology that couples the cache layer 108 to the cache layer 110-1. Likewise, the interconnect 114 includes one or more types of interface technology that couples the cache layer 110-2 to the cache layer 110-1, as well as various kinds of interface technology that couples the cache layer 110-N to the cache layer 110-2.

The interface technology of the interconnect 114 enables communications (e.g., cache controller requests, cache controller responses) to transfer between the cache layer 108 and each of the cache layer 110-1 through the cache layer 110-N. For example, the interconnect 114 is configured to pipeline the communications between the cache layer 108 and each of the cache layer 110-1 through the cache layer 110-N. The interconnect 114 enables communications to move up and down through the stacked cache 102 by passing, in a successive manner, from one of the cache layer 110-1 through the cache layer 110-N, to the next. For example, the interconnect 114 pipelines communications (e.g., requests) originating at the cache layer 108 up through one or more of the cache layer 110-1 through the cache layer 110-N. Likewise, communications originating the cache layer 110-1 through the cache layer 110-N (e.g., responses) are pipelined down the interconnect 114 through one or more of the cache layer 110-1 through the cache layer 110-N and to the cache layer 108.

In accordance with the described techniques, a delay logic 116-1 through a delay logic 116-N is arranged within each of the stacked die 106-1 through the stacked die 106-N between the interconnect 114 and a corresponding one of the cache layer 110-1 through the cache layer 110-N. For example, the delay logic 116-1 is arranged between an interface to the interconnect 114 and the cache layer 110-1, the delay logic 116-2 is located between an interface to the interconnect 114 and the cache layer 110-2, and the delay logic 116-N is positioned between the interconnect 114 and the cache layer 110-N.

The delay logic at each of the cache layer 110-1 through the cache layer 110-N is an electronic circuit (e.g., analog delay circuit, digital delay circuit, a timer, a buffer, a transistor delay circuit, a NAND gate delay, an OR gate delay, or other delay circuit) that is configured to uniquely delay each request output on the interconnect 114 according to a respective position within the stacked cache 102 of a responding cache layer that receives the request. For example, the delay logic 116-1 includes electronic circuitry that delays a request output on the interconnect 114 for the cache layer 110-1 for one cycle, the delay logic 116-2 includes electronic circuitry that delays a request output on the interconnect 114 for the cache layer 110-2 for two cycles, and so forth, with the delay logic 116-N including electronic circuitry for delaying a request output on the interconnect 114 for the cache layer 110-N for a quantity of N cycles.

In at least one example, the delay logic at each of the cache layers uniquely delays the responses according to a respective position of a responding cache layer within the stacked cache 102. The delay logic at each of the cache layer 110-1 through the cache layer 110-N is configured to uniquely delay each response output on the interconnect 114 according to a respective position within the stacked cache 102 of a responding cache layer to cause responses to reach the cache controller 112 on a same clock cycle. For example, the delay logic 116-1 delays a response generated on the interconnect 114 by the cache layer 110-1 for N cycles, the delay logic 116-2 delays a response output on the interconnect 114 by the cache layer 110-2 for two cycles, and so forth, with the delay logic 116-N delaying a response generated on the interconnect 114 by the cache layer 110-N for one cycle.

The delay logic 116-1 through the delay logic 116-N within each of the cache layer 110-1 through the cache layer 110-N is carefully tuned to cause responses to reach the cache controller 112 on a same clock cycle. For example, the delay logic 116-1 of the cache layer 110-1 through the delay logic 116-N of the cache layer 110-N configures the interconnect 114 to synchronize communication between the cache layer 108 and each of the cache layer 110-1 through the cache layer 110-N by pipelining responses from the cache layer 110-1 through the cache layer 110-N to each be ready at the cache layer 108 during a common clock cycle. With request and response communications being synchronized up and down the interconnect 114, the cache controller 112 is configured to process each of the responses received for its cache requests during a common clock cycle. By delaying requests and responses at each of the cache layer 110-1 through the cache layer 110-N by different amounts of time according to their relative positions in the stacked cache 102, the delay logic 116-1 through the delay logic 116-N allows responses to be received on the cache layer 108 at approximately the same time. In this way, the interconnect 114 is configured to synchronize the communication by causing a same (or approximately same) response latency between the cache controller 112 and each of the cache layers of the stacked cache 102. The cache controller 112 is configured to process the responses during the common clock cycle, which reduces complexity of the cache controller 112.

In one or more examples, the base die 104 includes delay logic for accessing the cache layer 108. The delay logic of the base die 104 in that case is similar to the delay logic 116-1 through the delay logic 116-N. For instance, are each of the responses from the stacked dies 106-1 through 106-N is set to arrive on a same cycle, in addition, each of the responses from the base die 104 is also received on the same cycle. In this way, responses from anywhere in the stacked cache 102 are received consistently on a same clock cycle. When cache requests are sent to the cache layer 108 as well as one or more of the cache layer 110-1 through the cache layer 110-N, responses arrive and are ready at the same time. In one or more implementations, the delay logic 116-1 through the delay logic 116-N and/or delay logic of the base die 104 is implemented within the interconnect 114. The electronic circuit that forms the interconnect 114 includes the delay logic 116-1 through the delay logic 116-N, in one or more aspects.

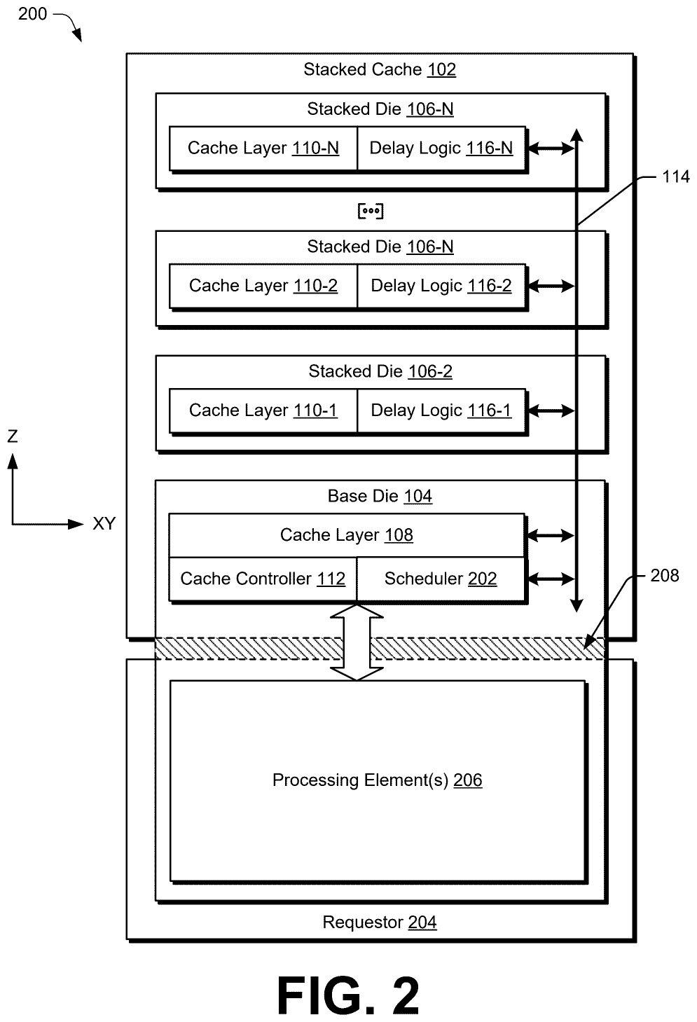

FIG. 2 is a block diagram of another non-limiting example of a system 200 that uses Z-dimension cache layer pipelining. The system 200 is similar to the system 100 and includes the stacked cache 102 formed from the stacked die 106-1 through the stacked die 106-N arranged in the Z-dimension above or below the base die 104. In addition, the system 200 includes the interconnect 114, which communicatively couples the base die 104 to each of the stacked die 106-1 through the stacked die 106-N. The system 200 includes one of the delay logic 116-1 through the delay logic 116-N at each of the cache layer 110-1 through the cache layer 110-N to carry cache requests from the cache controller 112, which trigger corresponding cache responses to be ready at the cache layer 108 for the cache controller 112 to process during a common clock cycle.

In addition to having similar components as the system 100 depicted in FIG. 1, the system 200 includes a scheduler 202. In one or more implementations, the scheduler 202 is an electronic circuit implemented on the base die 104. In one or more examples, the scheduler 202 is an electronic circuit implemented on a same die in the stack of dies as the cache controller 112. As depicted in FIG. 2, the scheduler 202 is an electronic circuit implemented with the cache layer 108 and configured to buffer cache responses that arrive on the interconnect 114 to each be ready for processing by the cache controller 112 during a common clock cycle. In one or more other examples, the scheduler 202 is implemented on a different die or different cache layer than the cache controller 112. The scheduler 202 is configured to buffer the responses for processing by the cache controller 112 during the common clock cycle. In one or more implementations, the scheduler 202 is implemented with the cache layer 108 to be separate from the cache controller 112. In variations, the scheduler 202 is implemented as part of the cache controller 112.

The scheduler 202 is communicatively coupled with the interconnect 114 to intercept cache responses received from the cache layer 110-1 through the cache layer 110-N. In at least one example, the scheduler 202 is configured to order each of the responses to be ready for processing by the cache controller 112 in the same order as the corresponding requests. For example, the delay logic 116-1 through the delay logic 116-N causes cache requests sent to the cache layer 110-1 through the cache layer 110-N to be delayed differently depending on positions of the cache layer 110-1 through the cache layer 110-N intended for the requests. The delay logic 116-1 through the delay logic 116-N further delays cache responses that the cache layer 110-1 through the cache layer 110-N output in response to the requests. With different delays applied to the requests and responses of the cache layer 110-1 through the cache layer 110-N, sometimes responses arrive at the base die 104 in a different order than an order that the requests are sent. In one or more examples, the scheduler 202 receives the responses from the interconnect 114 in a different order than a temporal order of the requests. To simplify operations performed by the cache controller 112 to process the requests during the common clock cycle, in one or more aspects, the scheduler 202 is configured to order each of the responses according to a temporal order of the requests that triggered the responses.

In addition to the scheduler 202 implemented on the base die 104 with the cache layer 108 and the cache controller 112, the system 200 includes a requestor 204. As depicted in FIG. 2, the requestor 204 includes one or more processing elements, labeled as processing elements 206, arranged on the base die 104. The processing elements 206, the cache layer 108, the cache controller 112, and the scheduler 202 are each arranged on the base die 104. However, the processing elements 206 are formed opposite a region 208 of the base die 104 that separates the stacked cache 102 from the requestor 204. In at least one variation, the requestor 204 and the processing elements 206 thereof are implemented on one or more of the base die 104 and the stacked die 106-1 through the stacked die 106-N. In at least one variation, the cache controller 112 and the requestor 204 are implemented on a same die among one or more of the base die 104 and the stacked die 106-1 through the stacked die 106-N. In at least one other variation, the cache controller 112 and the requestor 204 are implemented on different dies among two or more of the base die 104 and the stacked die 106-1 through the stacked die 106-N.

In keeping with the definition of requestor provided in the description of FIG. 1, the requestor 204 includes the processing elements 206 to perform processing operations, such as, reading and executing instructions (e.g., of a program, from software, from firmware). Examples of the requestor 204 and the processing elements 206 include, but are not limited to, a processing core, a CPU, a GPU, a FPGA, an accelerator, an APU, an IPU, and a DSP, to name a few. In one or more implementations, the stacked cache 102 is at least one of smaller than other data stores accessible to the requestor 204, faster at serving data to the requestor 204 than these other data stores, or more efficient at serving data to the requestor 204 than these other data stores. Additionally, or alternatively, the stacked cache 102 is located closer to the processing elements 206 than other data stores within the system 200. It is to be appreciated that in various implementations the stacked cache 102 has additional or different characteristics that make serving at least some data from the stacked cache 102 to the processing elements 206 advantageous over serving such data from other data stores in the system 200.

The processing elements 206 are operatively and communicatively coupled to the stacked cache 102. For example, the processing elements 206 execute instructions that require data to be loaded or stored at the stacked cache 102. The interface to the cache layer 108 receives messages from the processing elements 206 indicating the data to be loaded or stored. Based on the messages obtained from the requestor 204, the cache controller 112 generates cache requests that are sent via the interconnect 114 to the cache layer 110-1 through the cache layer 110-N. Cache responses are buffered and ordered by the scheduler 202 such that each of the responses are ready for processing by the cache controller 112 during a common clock cycle. In one or more examples, after the cache controller 112 processes the responses, the cache controller 112 outputs confirmations to the processing elements 206, which indicate the messages received from the requestor 204 are being processed.

In one or more implementations, the scheduler 202 is aware of a quantity of delay cycles caused by the delay logic 116-1 through the delay logic 116-N for each request and response associated with the cache layer 110-1 through the cache layer 110-N of the stacked cache 102. This awareness of the delay logic 116-1 through the delay logic 116-N configures the scheduler 202 to recognize when responses will return to the base die 104 and is also used to prevent conflicts on the interconnect 114. When the cache controller 112 sends a request up the interconnect 114 and through the cache layer 110-1 through the cache layer 110-N, the scheduler 202 knows when to expect a response coming back down the interconnect 114. A corresponding one of the delay logic 116-1 through the delay logic 116-N in each of the stacked die 106-1 through the stacked die 106-N prevents conflict on the interconnect 114 such that individual responses from two or more different dies of the stacked die 106-1 through the stacked die 106-N are transmittable down the interconnect 114 to be ready on the base die 104 during the same cycle.

The scheduler 202 manages the responses delayed by the delay logic 116-1 through the delay logic 116-N so that, from a perspective of the cache controller 112, each of the responses appear ready for processing in the cache layer 108 at approximately the same time. The responses are made available on a same clock cycle even though each response is individually received at the base die 104 on different clock cycles. For any requests issued to the stacked cache 102 on a given clock cycle, the scheduler 202 presents each of the responses to the cache controller 112 on the same cycle.

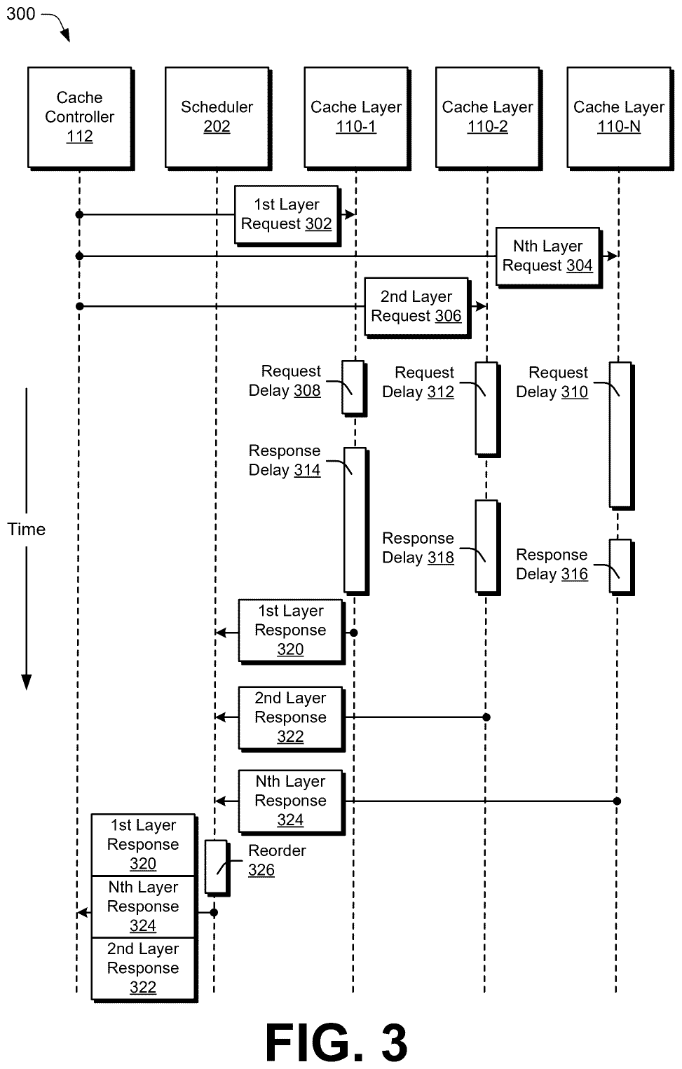

FIG. 3 depicts a timing diagram 300 of cache communications exchanged in a non-limiting example system using Z-dimension cache layer pipelining. In accordance with the described techniques, the timing diagram 300 conveys operations performed by a system or a device (e.g., a semiconductor device) that includes a stacked cache having a plurality of cache layers communicatively pipelined by an interconnect that outputs responses from the cache layers for processing during a common clock cycle. For ease of description, the timing diagram 300 is described in the context of the system 200, including with reference to similar labeled elements of the system 100. For example, a temporal order of operations and/or communications associated with the cache controller 112, the scheduler 202, and the cache layer 110-1 through the cache layer 110-N are shown in FIG. 3. Time increases from the top to the bottom of FIG. 3, as indicated by a downward pointing arrow.

From time to time, the cache controller 112 splits cache requests up into different portions of data. Each portion is sent to a different one of the cache layer 110-1 through the cache layer 110-N to enable the stacked cache 102 to process each part of the request in parallel. For example, assume each of the cache layer 110-1 through the cache layer 110-N is configured to process one thousand pieces of data and the stacked cache 102 has four cache layers (e.g., the cache layer 110-1 through the cache layer 110-N where N equals four). A function at the cache controller 112 or the scheduler 202 maps data for the stacked cache 102 to be distributed (e.g., evenly) among the four different cache layers. In practice, each of the cache layer 110-1 through the cache layer 110-N receives a request indicating an addressable data location and a specific quantity of bits corresponding to unique part of the data stored at that address. For example, the first quarter of bits at the address is processed by the cache layer 110-1 in response to a first request on the interconnect 114, the second quarter of bits at the address is processed by the cache layer 110-2 in response to a second request on the interconnect 114, and so forth, until the fourth quarter of bits at the address is processed by the cache layer 110-N in response to a fourth request on the interconnect 114.

The timing diagram 300 illustrates an order of operations and/or communications that travel up and down the interconnect 114 regardless of whether cache requests are split into multiple requests or requests are each referencing entire blocks of data. On the base die 104, the cache controller 112 causes a request 302 for access to the cache layer 110-1 to appear on the interconnect 114 during a first cycle. A request delay 308 is applied by the delay logic 116-1 to slow how fast the cache layer 110-1 receives the request 302. For example, the request delay 308 is one cycle long. In one or more implementations, the request 302 includes an instruction, a message, or a command interpreted by electronic circuits implemented at the cache layer 110-1 for data to be stored or retrieved from the stacked cache 102. For example, the cache controller 112 communicates the request 302 to the stacked cache 102 to cause existing data stored in the cache layer 110-1 to be retrieved from one or more storage circuits (e.g., cache layers) that maintain the data. As another example, the cache controller 112 communicates the request 302 to the stacked cache 102 to cause new data to be stored in the cache layer 110-1 to improve efficiency of a subsequent retrieval of the data (e.g., in response to a subsequent request) from one or more storage circuits (e.g., cache layers) where the data is stored.

After issuing the request 302, the cache controller 112 causes a request 304 for access to the cache layer 110-N to appear on the interconnect 114. In one or more implementations, the request 304 is an instruction, a command, or a message interpreted by a storage circuit of the cache layer 110-N to store data or retrieve data stored therein. A request delay 310 is applied by the delay logic 116-N to slow how fast the cache layer 110-N receives the request 304. For example, the request delay 310 is N (e.g., more than two) cycles long.

Finally, in this example, the cache controller 112 causes a request 306 for access to the cache layer 110-2 to appear on the interconnect 114. In at least one example, the request 306 is an instruction, a command, or a message interpreted by a storage circuit of the cache layer 110-2 to store data or retrieve data stored therein. A request delay 312 is applied by the delay logic 116-2 to slow how fast the cache layer 110-2 receives the request 306. For example, the request delay 312 is two cycles long.

A response 320 to the request 302 is generated by the cache layer 110-1. In one or more implementations, the response 320 includes an instruction, a message, or a command for confirming data that is stored or for conveying data retrieved from the stacked cache 102. For example, the cache controller 112 receives the response 320 from the stacked cache 102 as an indication of when data is successfully stored in one or more storage circuits of the cache layer 110-1. As another example, the cache controller 112 receives the response 320 from the stacked cache 102 as an indication of the data retrieved from one or more storage circuits of the cache layer 110-1. After a response delay 314 is applied by the delay logic 116-1, the response 320 returns down the interconnect 114. For example, the response delay 314 is N cycles long. The response 320 is trapped by the scheduler 202 to prevent the response 320 from reaching the cache controller 112 until responses to each of the requests (e.g., the request 302, the request 304, and the request 306) to the stacked cache 102 are ready.

A response 322 to the request 306 is generated by the cache layer 110-2. In one or more implementations, the response 322 is an instruction, a command, or a message that indicates to the cache controller 112 a confirmation that data is stored at the cache layer 110-2 or includes the data retrieved from the cache layer 110-2. After a response delay 318 is applied by the delay logic 116-2, the response 322 returns down the interconnect 114. For example, the response delay 318 is two cycles long. The response 322 is trapped by the scheduler 202 to prevent the response 322 from reaching the cache controller 112 until responses to each of the requests to the stacked cache 102 are ready.

Finally, a response 324 to the request 306 is generated by the cache layer 110-N. In one or more implementations, the response 324 is an instruction, a command, or a message that indicates to the cache controller 112 a confirmation that data is stored at the cache layer 110-N or includes the data retrieved from the cache layer 110-N. After a response delay 316 is applied by the delay logic 116-N, the response 324 returns down the interconnect 114. For example, the response delay 316 is one cycle long. The scheduler 202 traps the response 324 within the cache layer 108 to prevent the response 324 from reaching the cache controller 112 until responses to each of the requests to the stacked cache 102 are ready.

Within the cache controller 112, or within separate logic, the scheduler 202 orders each of the responses to be ready for the cache controller 112 on a same clock cycle. For example, the scheduler 202 assigns the response 320 received first in time on the interconnect 114 to the cache layer 110-1, the response 322 received second in time is assigned to the cache layer 110-2, and the response 324 received last in time is assigned to the cache layer 110-N.

Upon receiving each of the responses, the scheduler 202 applies a reorder 326. For example, to match the order of their corresponding requests, the response 324 is ordered after the response 320 and before the response 322. Then, the response 320, the response 324, and the response 322 are indicated by the scheduler 202 as being ready for processing by the cache controller 112 during the same clock cycle.

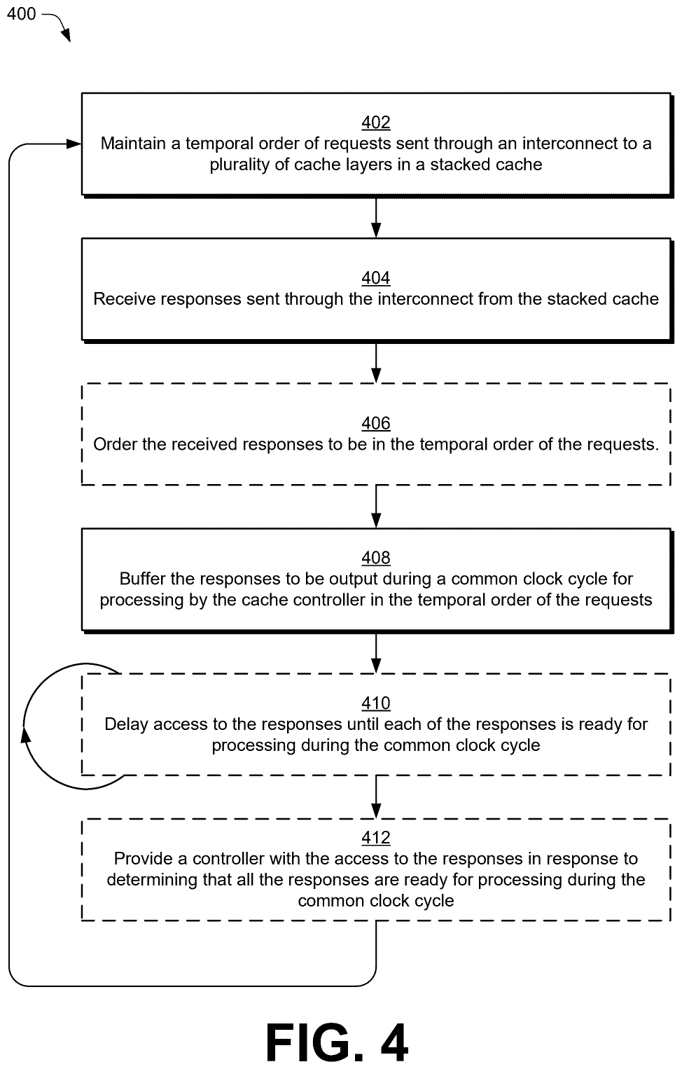

FIG. 4 depicts a procedure 400 for using Z-dimension cache layer pipelining. The procedure 400 includes multiple operations illustrated as block 402 through block 412 and provides just one example procedure performed within the system 100 and/or the system 200. The procedure 400 is not limited to the order of operations shown in FIG. 4, other orderings of the block 402 through the block 412 is possible. In one or more implementations, the procedure 400 includes additional or fewer operations than those depicted in FIG. 4.

A temporal order of requests sent through an interconnect to a plurality of cache layers in a stacked cache is maintained by a scheduler in communication with a cache controller (block 402). In operation, the scheduler 202 keeps track of a temporal order that each of the request 302, the request 304, and the request 306 are sent out on the interconnect 114 by the cache controller 112. The scheduler 202 is aware of individual delays caused by each of the delay logic 116-1 through the delay logic 116-N. For example, the scheduler 202 determines when the response 320, the response 322, and the response 324 are expected to return down the interconnect 114.

Responses sent through the interconnect are received from the stacked cache (block 404). In one or more implementations, the scheduler 202 prevents the response 320, the response 322, and the response 324 from being made available to the cache controller 112 until a later time then when each is received.

Optionally, the responses are ordered to be buffered in the temporal order of the requests (block 406). In one or more aspects, the scheduler 202 applies the reorder 326 to the response 320, the response 322, and the response 324 to cause them to be made available to the cache controller 112 in the same temporal order of a corresponding one of the request 302, the request 304, and the request 306. By maintaining the temporal order at the block 402, the scheduler 202 can easily reorder the response 320, the response 322, and the response 324 so the cache controller 112 does not have to. This reordering scheme helps reduce complexity of the cache controller 112.

The responses are buffered to be output during a common clock cycle for processing by the cache controller in the temporal order of the requests (block 408). In operation, the scheduler 202 keeps the response 320, the response 322, and the response 324 in a location of the cache layer 108 until each response for a given clock cycle are received from the cache layer 110-1 through the cache layer 110-N. This way, the scheduler 202 prevents the cache controller 112 access to the responses until a corresponding response to each of the requests is received for processing during the common clock cycle.

Optionally, access to the responses is delayed until each of the responses is ready for processing during the common clock cycle (block 410). In one or more implementations, the scheduler 202 restricts access to the location of a buffer maintained in the cache layer 108 where the response 320, the response 322, and the response 324 are buffered by the scheduler 202. Restrictions on the access to the buffer are removed when the scheduler 202 determines that each of the responses for a given clock cycle are received from the cache layer 110-1 through the cache layer 110-N and arranged in order within the buffer maintained in the cache layer 108.

Optionally, the controller is provided with the access to the responses in response to determining that each of the responses are ready for processing during the common clock cycle (block 412). In one or more examples, the response 320, the response 322, and the response 324 are made available to the cache controller 112 at the same time. The scheduler 202 gives the cache controller 112 access to the response buffer maintained in the cache layer 108 to enable the cache controller 112 to process the responses in the temporal order of its requests.

Rather than inconsistent cache latency experienced with conventional stacked cache pipelining schemes, the procedure 400 causes a response latency at the stacked cache 102 to be constant, no matter the quantity of the cache layer 110-1 through the cache layer 110-N. The procedure 400 is compatible with any quantity of the cache layer 110-1 through the cache layer 110-N. Unlike conventional designs where a stacked cache is limited to only one or two layers, the stacked cache 102 does not rely on complex analog circuitry to deconflict communications transferred up and down the interconnect 114. Instead, the delay logic 116-1 through the delay logic 116-N and/or the scheduler 202 prevents conflicts and ensures responses are received by the cache controller 112 in furtherance of their efficient processing.

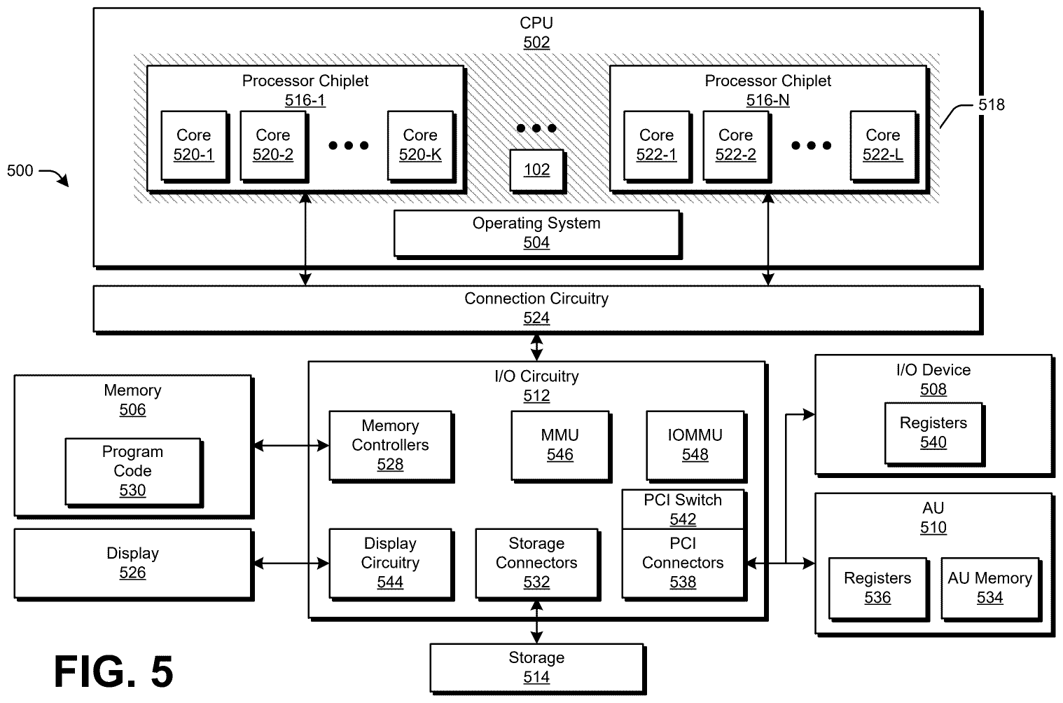

FIG. 5 includes a processing system 500 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 500 includes a central processing unit (CPU) 502. In one or more implementations, the CPU 502 is configured to run an operating system (OS) 504 that manages the execution of applications. For example, the OS 504 is configured to schedule the execution of tasks (e.g., instructions) for applications, allocate portions of resources (e.g., system memory 506, CPU 502, input/output (I/O) device 508, accelerator unit (AU) 510, storage 514) for the execution of tasks for the applications, provide an interface to I/O devices (e.g., I/O device 508) for the applications, or any combination thereof.

In this example, one or multiple implementations of the stacked cache 102 are depicted in the CPU 502. In variations, however, one or multiple implementations of the stacked cache 102 are included in and/or are implemented by one or more different components of the processing system 500, such as the CPU 502, the memory 506, the I/O device 508, the AU 510, the I/O circuitry 512, the storage 514, and so forth. In at least one implementation, the stacked cache 102 or portions of the stacked cache 102 are included in at least two of the depicted components of the processing system 500. By way of example, the stacked cache 102 may be included in or otherwise implemented by at least the CPU 502 and the AU 510.

The CPU 502 includes one or more processor chiplets 516, which are communicatively coupled together by a data fabric 518 in one or more implementations. The one or multiple implementations of the stacked cache 102 of the CPU 502 are also communicatively coupled via the data fabric 518 to one or a plurality of the processor chiplets 516. For example, the CPU 502 is an example of the requestor 204 and each of the processor chiplets 516 is an example of one or more of the processing elements 206. The processor chiplets 516 are configured to access the stacked cache 102 of the CPU 502 in at least one variation by communicating and exchanging data over connections or links implemented by the data fabric 518. In one or more examples, the processor chiplets 516 include local implementations of the stacked cache 102 of the CPU 502 and communicate and exchanging data over internal connections or links implemented within the processor chiplets 516 or separate from the data fabric 518.

Each of the processor chiplets 516, for example, includes one or more processor cores 520, 522 configured to concurrently execute one or more series of instructions, also referred to herein as “threads,” for an application. Further, the data fabric 518 communicatively couples each processor chiplet 516-N of the CPU 502 such that each processor core (e.g., processor cores 520) of a first processor chiplet (e.g., 516-1) is communicatively coupled to each processor core (e.g., processor cores 522) of one or more other processor chiplets 516. Though the example embodiment presented in FIG. 5 shows a first processor chiplet (516-1) having three processor cores (520-1, 520-2, 520-K) representing a K number of processor cores 522 and a second processor chiplet (516-N) having three processor cores (e.g., 522-1, 522-2, 522-L) representing an L number of processor cores 522, in other implementations (L being an integer number greater than or equal to one), each processor chiplet 516 may have any number of processor cores 520, 522. For example, each processor chiplet 516 can have the same number of processor cores 520, 522 as one or more other processor chiplets 516, a different number of processor cores 520, 522 as one or more other processor chiplets 516, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

Additionally, within the processing system 500, the CPU 502 is communicatively coupled to an I/O circuitry 512 by a connection circuitry 524. For example, each processor chiplet 516 of the CPU 502 is communicatively coupled to the I/O circuitry 512 by the connection circuitry 524. The connection circuitry 524 includes, for example, one or more data fabrics, buses, buffers, queues, and the like. The I/O circuitry 512 is configured to facilitate communications between two or more components of the processing system 500 such as between the CPU 502, system memory 506, display 526, universal serial bus (USB) devices, peripheral component interconnect (PCI) devices (e.g., I/O device 508, AU 510), storage 514, and the like.

As an example, system memory 506 includes any combination of one or more volatile memories and/or one or more non-volatile memories, examples of which include dynamic random-access memory (DRAM), static random-access memory (SRAM), non-volatile RAM, and the like. To manage access to the system memory 506 by CPU 502, the I/O device 508, the AU 510, and/or any other components, the I/O circuitry 512 includes one or more memory controllers 528. These memory controllers 528, for example, include circuitry configured to manage and fulfill memory access requests issued from the CPU 502, the I/O device 508, the AU 510, or any combination thereof. Examples of such requests include read requests, write requests, fetch requests, pre-fetch requests, or any combination thereof. That is to say, these memory controllers 528 are configured to manage access to the data stored at one or more memory addresses within the system memory 506, such as by CPU 502, the I/O device 508, and/or the AU 510.

When an application is to be executed by processing system 500, the OS 504 running on the CPU 502 is configured to load at least a portion of program code 530 (e.g., an executable file) associated with the application from, for example, a storage 514 into system memory 506. This storage 514, for example, includes a non-volatile storage such as a flash memory, solid-state memory, hard disk, optical disc, or the like configured to store program code 530 for one or more applications.

To facilitate communication between the storage 514 and other components of processing system 500, the I/O circuitry 512 includes one or more storage connectors 532 (e.g., universal serial bus (USB) connectors, serial AT attachment (SATA) connectors, PCI Express (PCIe) connectors) configured to communicatively couple storage 514 to the I/O circuitry 512 such that I/O circuitry 512 is capable of routing signals to and from the storage 514 to one or more other components of the processing system 500.

In association with executing an application, in one or more scenarios, the CPU 502 is configured to issue one or more instructions (e.g., threads) to be executed for an application to the AU 510. The AU 510 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 510 includes one or more compute units that concurrently execute one or more threads of an application and store data resulting from the execution of these threads in AU memory 534. This AU memory 534, for example, includes any combination of one or more volatile memories and/or non-volatile memories, examples of which include caches, video RAM (VRAM), or the like. In one or more implementations, these compute units are also configured to execute these threads based on the data stored in one or more physical registers 536 of the AU 510.

To facilitate communication between the AU 510 and one or more other components of processing system 500, the I/O circuitry 512 includes or is otherwise connected to one or more connectors, such as PCI connectors 538 (e.g., PCIe connectors) each including circuitry configured to communicatively couple the AU 510 to the I/O circuitry such that the I/O circuitry 512 is capable of routing signals to and from the AU 510 to one or more other components of the processing system 500. Further, the PCIe connectors 538 are configured to communicatively couple the I/O device 508 to the I/O circuitry 512 such that the I/O circuitry 512 is capable of routing signals to and from the I/O device 508 to one or more other components of the processing system 500.

By way of example and not limitation, the I/O device 508 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 508 is configured to execute one or more operations, tasks, instructions, or any combination thereof based on one or more physical registers 540 of the I/O device 508. In one or more implementations, such physical registers 540 are configured to maintain data (e.g., operands, instructions, values, variables) indicating one or more operations, tasks, or instructions to be performed by the I/O device 508.

To manage communication between components of the processing system 500 (e.g., AU 510, I/O device 508) that are connected to PCI connectors 538, and one or more other components of the processing system 500, the I/O circuitry 512 includes PCI switch 542. The PCI switch 542, for example, includes circuitry configured to route packets to and from the components of the processing system 500 connected to the PCI connectors 538 as well as to the other components of the processing system 500. As an example, based on address data indicated in a packet received from a first component (e.g., CPU 502), the PCI switch 542 routes the packet to a corresponding component (e.g., AU 510) connected to the PCI connectors 538.

Based on the processing system 500 executing a graphics application, for instance, the CPU 502, the AU 510, or both are configured to execute one or more instructions (e.g., draw calls) such that a scene including one or more graphics objects is rendered. After rendering such a scene, the processing system 500 stores the scene in the storage 514, displays the scene on the display 526, or both. The display 526, for example, includes a cathode-ray tube (CRT) display, liquid crystal display (LCD), light emitting diode (LED) display, organic light emitting diode (OLED) display, or any combination thereof. To enable the processing system 500 to display a scene on the display 526, the I/O circuitry 512 includes display circuitry 544. The display circuitry 544, for example, includes high-definition multimedia interface (HDMI) connectors, DisplayPort connectors, digital visual interface (DVI) connectors, USB connectors, and the like, each including circuitry configured to communicatively couple the display 526 to the I/O circuitry 512. Additionally or alternatively, the display circuitry 544 includes circuitry configured to manage the display of one or more scenes on the display 526 such as display controllers, buffers, memory, or any combination thereof.

Further, the CPU 502, the AU 510, or both are configured to concurrently run one or more virtual machines (VMs), which are each configured to execute one or more corresponding applications. To manage communications between such VMs and the underlying resources of the processing system 500, such as any one or more components of processing system 500, including the CPU 502, the I/O device 508, the AU 510, and the system memory 506, the I/O circuitry 512 includes memory management unit (MMU) 546 and input-output memory management unit (IOMMU) 548. The MMU 546 includes, for example, circuitry configured to manage memory requests, such as from the CPU 502 to the system memory 506. For example, the MMU 546 is configured to handle memory requests issued from the CPU 502 and associated with a VM running on the CPU 502. These memory requests, for example, request access to read, write, fetch, or pre-fetch data residing at one or more virtual addresses (e.g., guest virtual addresses) each indicating one or more portions (e.g., physical memory addresses) of the system memory 506. Based on receiving a memory request from the CPU 502, the MMU 546 is configured to translate the virtual address indicated in the memory request to a physical address in the system memory 506 and to fulfill the request. The IOMMU 548 includes, for example, circuitry configured to manage memory requests (memory-mapped I/O (MMIO) requests) from the CPU 502 to the I/O device 508, the AU 510, or both, and to manage memory requests (direct memory access (DMA) requests) from the I/O device 508 or the AU 510 to the system memory 506. For example, to access the registers 540 of the I/O device 508, the registers 536 of the AU 510, and/or the AU memory 534, the CPU 502 issues one or more MMIO requests. Such MMIO requests each request access to read, write, fetch, or pre-fetch data residing at one or more virtual addresses (e.g., guest virtual addresses) which each represent at least a portion of the registers 540 of the I/O device 508, the registers 536 of the AU 510, or the AU memory 534, respectively. As another example, to access the system memory 506 without using the CPU 502, the I/O device 508, the AU 510, or both are configured to issue one or more DMA requests. Such DMA requests each request access to read, write, fetch, or pre-fetch data residing at one or more virtual addresses (e.g., device virtual addresses) which each represent at least a portion of the system memory 506. Based on receiving an MMIO request or DMA request, the IOMMU 548 is configured to translate the virtual address indicated in the MMIO or DMA request to a physical address and fulfill the request.

In variations, the processing system 500 can include any combination of the components depicted and described. For example, in at least one variation, the processing system 500 does not include one or more of the components depicted and described in relation to FIG. 5. Additionally or alternatively, in at least one variation, the processing system 500 includes additional and/or different components from those depicted. The 500 is configurable in a variety of ways with different combinations of components in accordance with the described techniques.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (e.g., the cache controller 112, the delay logic 116-1 through the delay logic 116-N, the scheduler 202, the requestor 204, the processing elements 206) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a CPU, a DSP, a GPU, a parallel accelerated processor, a plurality of microprocessors, one or more microprocessors in association with a DSP core, a controller, a microcontroller, an Application Specific Integrated Circuit (ASIC), a FPGA circuit, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read-only memory (ROM), a random-access memory (RAM), a register, cache memory, semiconductor memory devices, magnetic media such as internal hard disks and removable disks, magneto-optical media, and optical media such as a CD-ROM disk, or a digital versatile disk (DVD).

1. A system comprising:
a stacked cache having a plurality of cache layers, each cache layer implemented on a different respective die within a stack of dies;
a cache controller configured to send a plurality of requests to the cache layers and process a plurality of responses received from the cache layers in response to the plurality of requests; and
an interconnect configured to synchronize communication between the cache controller and the stacked cache by pipelining each of the plurality of responses to arrive at the cache controller during a common clock cycle for processing in response to the plurality of requests.

2. The system of claim 1, wherein the cache controller is configured to process the plurality of responses during a period of time defined by the common clock cycle.

3. The system of claim 1, wherein the interconnect is further configured to synchronize the communication by causing an approximately same response latency between the cache controller and each of the cache layers.

4. The system of claim 1, further comprising:
a scheduler configured to buffer the plurality of responses for processing by the cache controller during the common clock cycle.

5. The system of claim 4, wherein the scheduler is implemented on a same die in the stack of dies as the cache controller.

6. The system of claim 4, wherein the scheduler is configured to order each of the plurality of responses according to a temporal order of the plurality of requests.

7. The system of claim 6, wherein the scheduler is configured to receive the plurality of responses in a different order than the temporal order of the plurality of requests.

8. The system of claim 1, wherein the interconnect comprises delay logic at each of the cache layers to uniquely delay the plurality of responses according to a respective position of a responding cache layer within the stacked cache.

9. The system of claim 1, wherein the cache controller is implemented on a same die in the stack of dies as a first cache layer in the stacked cache.

10. The system of claim 1, wherein the interconnect comprises micro bumps, hybrid bonds, or through-silicon vias that electrically couple each of the cache layers to at least one adjacent cache layer from the stacked cache.

11. A device comprising:
a stacked cache having a plurality of cache layers communicatively pipelined by an interconnect that outputs a plurality of responses from the cache layers to arrive at a cache controller during a common clock cycle for processing in response to a plurality of requests.

12. The device of claim 11, wherein each of the cache layers is implemented on a different respective die within a stack of dies.

13. The device of claim 11, wherein the interconnect comprises delay logic at each of the cache layers to cause an approximately same response latency from each of the cache layers.

14. The device of claim 11, further comprising:
the cache controller configured to send the plurality of requests to the cache layers and process the plurality of responses from the cache layers during the common clock cycle.

15. The device of claim 14, wherein the cache controller comprises a scheduler that orders the plurality of responses based on a temporal order of the plurality of requests for processing by the cache controller during the common clock cycle.

16. (canceled)

17. The device of claim 11, further comprising:
a processor operatively coupled to the stacked cache.

18. A method comprising:
maintaining, by a scheduler in communication with a cache controller, a temporal order of a plurality of requests pipelined through an interconnect to a plurality of cache layers in a stacked cache;
receiving, by the scheduler, a plurality of responses pipelined through the interconnect from the stacked cache; and
buffering, by the scheduler, the plurality of responses to be output during a common clock cycle for processing by the cache controller in the temporal order of the plurality of requests.

19. The method of claim 18,
wherein the plurality of responses are received in a different order than the temporal order of the plurality of requests, and
buffering the plurality of responses comprises ordering the plurality of responses to be buffered in the temporal order of the plurality of requests.

20. The method of claim 18, further comprising:
preventing, by the scheduler, cache controller access to the plurality of responses until a corresponding response to each of the plurality of requests is received for processing during the common clock cycle.

21. The system of claim 1, wherein the common clock cycle is a single clock cycle common to each of the plurality of requests.
